(19) United States
(12) Patent Application Publication
(10) Pub. No.: US 2026/0266776 A1
(43) Pub. Date: Sep. 10, 2026

(54) AUTOMATED CALIBRATION CURVE

(71) Applicant: Waters Technologies Corporation, Milford, MA (US)

(72) Inventors: Michael O. Fogwill, Uxbridge, MA (US); Susan Abbatiello, Reading, MA (US)

(21) Appl. No.: 19/556,539

(22) Filed: Mar. 4, 2026

Related U.S. Application Data
(60) Provisional application No. 63/766,787, filed on Mar. 4, 2025.

(51) Int. Cl. G01N 30/62; G01N 30/02

(52) U.S. Cl. CPC G01N 30/62; G01N 2030/027; G01N 2030/626

(57) ABSTRACT

A method for performing liquid chromatography calibration includes submitting a sample into a liquid chromatography sample manager system and providing the liquid chromatography sample manager system with a known concentration of the sample. The method includes providing, by the liquid chromatography sample manager system, the sample at a first concentration to a chromatography column and detector and providing the sample at a second concentration to the chromatography column and the detector. The method includes automatically generating, by the liquid chromatography sample manager system, a calibration curve after detecting the sample at multiple concentrations including the first concentration and the second concentration. A liquid chromatography sample manager and/or liquid chromatography system including a sample manager is further provided that is configured to perform the method.

### RELATED APPLICATION

This application claims priority to U.S. Provisional Patent Application No. 63/766,787 filed on Mar. 4, 2025, the entirety of which is incorporated by reference herein.

### FIELD OF THE INVENTION

The disclosed technology generally relates to liquid chromatography. More particularly, the technology relates to methods and systems for calibrating liquid chromatography sample manager and/or system and a process for automatically generating a calibration curve.

### BACKGROUND

There is a need in the art of liquid chromatography (LC) for improved solutions to apply in quality assurance and quality control (QA/QC) labs for injectable substances. In the context of liquid chromatography calibration, calibration curves are required for providing standards for detection calibration for quantitative analysis in liquid chromatography. To create a calibration curve, a system must run detect a peak response with known concentrations of calibrant at multiple different concentrations. Manual pipetting is generally required to provide samples of calibrants at these specific known concentrations. Further, manual transcription of information (i.e. the input of the known concentrations, vial location coordinates, etc.). Overall, the manual nature of the various steps required to form a calibration curve make the process time consuming and opens the possibility for sample preparation and transcription errors.

Therefore, improved devices and methods for automatically generating a calibration curve for LC detection would be well received in the art.

### SUMMARY

In one aspect, a method for performing liquid chromatography calibration includes submitting a sample into a liquid chromatography sample manager system; providing the liquid chromatography sample manager system with a known concentration of the sample; providing, by the liquid chromatography sample manager system, the sample at a first concentration to a chromatography column and detector; providing the sample at a second concentration to the chromatography column and the detector; and automatically generating, by the liquid chromatography sample manager system, a calibration curve after detecting the sample at multiple concentrations including the first concentration and the second concentration.

Additionally or alternatively, the method includes reporting the automatically generated calibration curve to a user interface in communication with the liquid chromatography sample manager system.

Additionally or alternatively, the method includes prior to the automatically generating the calibration curve, providing the liquid chromatography sample manager system with a calibration curve range.

Additionally or alternatively, the method includes automatically determining, by the liquid chromatography sample manager system, a dilution procedure to create the multiple concentrations using the calibration curve range.

Additionally or alternatively, the automatically generating the calibration curve by detecting the sample at multiple concentrations further comprises: automatically diluting, by the liquid chromatography sample manager system, the sample in accordance with the dilution procedure to the multiple concentrations; and injecting, by the liquid chromatography sample manager system, each of the multiple concentrations into a liquid chromatography system.

Additionally or alternatively, the method includes automatically washing, by the liquid chromatography sample manager system, the fluidics of the liquid chromatography sample manager system used during the automatically generating the calibration curve after the automatically diluting and injecting of each of the multiple concentrations to reduce response carry over.

Additionally or alternatively, the response carry over is 0.02% units or less.

Additionally or alternatively, the method includes submitting at least one empty vial into the liquid chromatography sample manager system, wherein the at least one empty vial is used by the liquid chromatography sample manager system for diluting the sample and creating the multiple concentrations.

Additionally or alternatively, the method includes injecting a sample of unknown concentration into a liquid chromatography system; and detecting, by the liquid chromatography sample manager system, that the unknown concentration is outside a calibration curve range of the calibration curve.

Additionally or alternatively, in response to the detecting, by the liquid chromatography sample manager system, that the unknown concentration is outside the calibration curve range of the calibration curve, the method includes: automatically diluting, by the liquid chromatography sample manager system, the sample of unknown concentration with a dilution ratio that results in the concentration to be inside the calibration curve range; and injecting, by the liquid chromatography sample manager system, the sample of unknown concentration with the dilution ratio into the liquid chromatography system.

Additionally or alternatively, the automatically diluting includes a plurality of dilution stages.

Additionally or alternatively, the method includes using a complex biological matrix as a diluent when creating the multiple concentrations of the sample.

Additionally or alternatively, the method includes receiving, by the liquid chromatography sample manager system, a plurality of user-specified target concentrations, wherein the multiple concentrations include the plurality of user-specified target concentrations.

Additionally or alternatively, the method includes receiving, by the liquid chromatography sample manager system, a number of concentrations to be used for generating the calibration curve.

Additionally or alternatively, the method includes receiving, by the liquid chromatography sample manager system, a number of replicate injections to be performed at each of the multiple concentrations.

In another aspect, a liquid chromatography sample manager includes a receptor configured to receive a sample; and a calibration system configured to: receive information including a known concentration of the sample; provide the sample at a first concentration to a chromatography column and detector; provide the sample at the second concentration to the chromatography column and the detector; and without human intervention, automatically generate a calibration curve after detecting the sample at multiple concentrations including the first concentration and the second concentration.

Additionally or alternatively, the calibration system is further configured to report the automatically generated calibration curve to a user interface in communication with the liquid chromatography sample manager system.

Additionally or alternatively, the calibration system is further configured to receive a calibration curve range from a user and automatically determine a dilution procedure to create the multiple concentrations using the calibration curve range.

Additionally or alternatively, the calibration system is further configured to receive a number of calibrants and/or the number of replicate injections at each concentration of the multiple concentrations to generate the calibration curve.

Additionally or alternatively, the calibration system is further configured to receive a plurality of user-specified target concentrations, wherein the multiple concentrations include the plurality of user-specified target concentrations.

Additionally or alternatively, the calibration system is further configured to: automatically dilute the sample in accordance with the dilution procedure to the multiple concentrations; and inject the multiple concentrations into a liquid chromatography system.

Additionally or alternatively, the calibration system is further configured to automatically wash the fluidics of the liquid chromatography sample manager system used while generating the calibration curve after automatically diluting and injecting of each of the multiple concentrations to reduce response carry over.

Additionally or alternatively, the response carry over is 0.02% units or less.

Additionally or alternatively, the receptor is further configured to receive at least one empty vial, wherein the at least one empty vial is used by the liquid chromatography sample manager system for diluting the sample and creating the multiple concentrations.

Additionally or alternatively, the calibration system is further configured to: inject a sample of unknown concentration into a liquid chromatography system; detect that the unknown concentration is outside a calibration curve range of the calibration curve; automatically dilute the sample of unknown concentration with a dilution ratio that results in the concentration to be inside the calibration curve range; and inject the sample of unknown concentration with the dilution ratio into the liquid chromatography system.

In another aspect, a method for performing liquid chromatography includes: generating, by a liquid chromatography system, a calibration curve; injecting a sample of unknown concentration into a liquid chromatography system; and detecting, by the liquid chromatography system, that the unknown concentration is outside a calibration curve range of the calibration curve.

Additionally or alternatively, the method includes automatically diluting, by the liquid chromatography system, the sample of unknown concentration with a dilution ratio that results in the concentration to be inside the calibration curve range in response to the detecting, by the liquid chromatography system, that the unknown concentration is outside the calibration curve range of the calibration curve.

Additionally or alternatively, the method includes injecting, by the liquid chromatography system, the sample of unknown concentration with the dilution ratio into the liquid chromatography system.

Additionally or alternatively, the automatically diluting includes a plurality of dilution stages.

Additionally or alternatively, the method includes reporting the calibration curve to a user interface in communication with the liquid chromatography system.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts a schematic representation of a liquid chromatography system, in accordance with one embodiment.

FIG. 2 depicts a manual workflow for creating a calibration curve for a liquid chromatography system in accordance with a prior art method.

FIG. 3 depicts a data input user interface requiring manual entries of information in accordance with the prior art method.

FIG. 4 depicts an automated workflow for creating a calibration curve for a liquid chromatography system, in accordance with one embodiment.

FIG. 5 depicts a calibration curve generated by the automated workflow of FIG. 4, in accordance with one embodiment.

FIG. 6 depicts a calibration curve having an unknown concentration detected outside the calibration curve, in accordance with one embodiment.

FIG. 7 depicts a calibration curve having the unknown concentration of FIG. 6 detected inside the calibration curve after an automated dilution process, in accordance with one embodiment.

FIG. 8 depicts a method for performing liquid chromatography calibration, in accordance with one embodiment.

FIG. 9 depicts a method for automatically detecting that an unknown concentration is outside a calibration curve and performing an auto dilution process on a sample, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments described herein provide for creating a sample manager that is capable of performing automatic or automated calibration of detectors and/or calibration curves. Leveraging an automated dilution system, it is contemplated that a single source of concentrated sample is automatically diluted and injected at multiple concentrations to automatically form a calibration curve for the system. Moreover, embodiments described herein include detecting that an unknown concentration is outside a generated calibration curve and then leveraging automated dilution in order to re-inject a diluted unknown that is within the calibration curve due to the dilution process.

Thus, embodiments described herein below provide for a sample manager with the ability to draw an injectable substance or sample from an original capped vial (i.e. final packaging) or sample container and dilute the sample and inject the sample into a liquid chromatograph using a self-contained dilution system. “Self-contained” herein means a dilution system within the sample fluidics of the sample manager without the need for additional empty dilution vials. Rather, embodiments described herein contemplate inserting a sample (i.e. injectable substance) in a sample container (i.e. original capped vial) into a sample manager system and performing dilution using only the self-contained components such as an internal storage loop and/or dilution tower within the sample manager system, without requiring additional empty containers being inserted into the system by a technician to be used during the dilution process. The present invention further contemplates a wash system whereby the dilution system (i.e. the sample loop and/or dilution tower) will be washed after every dilution sequence or stage in order to make such self-contained dilution components reusable for the dilution processes described herein.

Embodiments further include flow through needle injections, and injections at dilution factors of at least 250. Advantageously, embodiments described herein provide for minimized oxidation of the sample during dilution and injection. Washing after each dilution sequence may include washing the dilution system to a standard so that less than 0.02% units of response carry over. In other embodiments, washing may include reducing response carry over to even lesser amounts, such as 0.002%, 0.005%, 0.01% units or less. This washing may be included in various system components requiring dilution (i.e., needles, fluidic paths, storage loops and/or dilution towers, etc.).

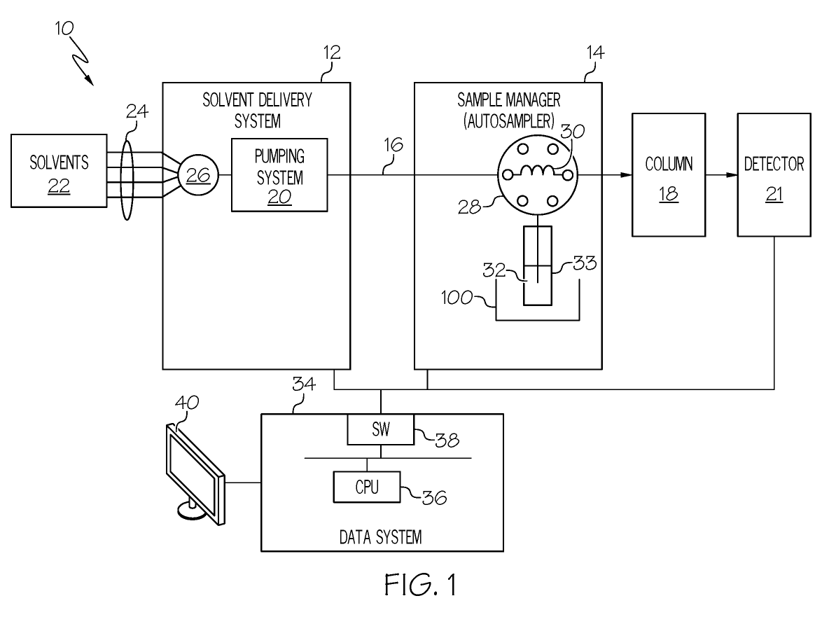

The features of the sample delivery system and sample manager described herein may be applicable to any liquid chromatography system configured to deliver samples into a chromatographic flow stream. As one example, FIG. 1 shows an embodiment of a liquid chromatography system 10 for separating a mixture into its constituents. The liquid chromatography system 10 includes a solvent delivery system 12 in fluidic communication with a sample manager 14 (also called an injector or an autosampler) through tubing 16. The sample manager 14 is in fluidic communication with a chromatographic column 18. A detector 21 for example, a mass spectrometer, is in fluidic communication with the column 18 to receive the elution.

The solvent delivery system 12 includes a pumping system 20 in fluidic communication with solvent reservoirs 22 from which the pumping system 20 draws solvents (liquid) through tubing 24. In one embodiment, the pumping system 20 is embodied by a low-pressure mixing gradient pumping system having two pumps fluidically connected in series. In the low-pressure gradient pumping system, the mixing of solvents occurs before the pump, and the solvent delivery system 12 has a mixer 26 in fluidic communication with the solvent reservoirs 22 to receive various solvents in metered proportions. This mixing of solvents (mobile phase) composition that varies over time (i.e., the gradient).

The pumping system 20 is in fluidic communication with the mixer 26 to draw a continuous flow of gradient therefrom for delivery to the sample manager 14. Examples of solvent delivery systems that can be used to implement the solvent delivery system 12 include, but are not limited to, the ACQUITY Binary Solvent Manager and the ACQUITY Quaternary Solvent Manager, manufactured by Waters Corp. of Milford, Mass.

The sample manager 14 may include an injector valve 28 having a sample loop 30. The sample manager 14 operates in one of two states: a load state and an injection state. In the load state, the position of the injector valve 28 is such that the sample manager loads the sample 32 into the sample loop 30. The sample 32 is drawn from a vial contained by a sample vial carrier. "Sample vial carrier" herein means any device configured to carry a sample vial such as a well plate, sample vial carrier, or the like. In the injection state, the position of the injector valve 28 changes so that the sample manager 14 introduces the sample in the sample loop 30 into the continuously flowing mobile phase from the solvent delivery system. The mobile phase thus carries the sample into the column 18. In other embodiments, a flow through needle (FTN) may be utilized instead of a Fixed-Loop sample manager. Using an FTN approach, the sample may be pulled into the needle and then the needle may be moved into a seal. The valve may then be switched to make the needle in-line with the solvent delivery system.

The liquid chromatography system 10 further includes a data system 34 that is in signal communication with the solvent delivery system 12 and the sample manager 14. The data system 34 has a processor 36 and a switch 38 (e.g. an Ethernet switch) for handling signal communication between the solvent delivery system 12 and sample manager 14, as described herein. Signal communication among the various systems and instruments can be electrical or optical, using wireless or wired transmission. A host computing system 40 is in communication with the data system 34 by which a technician can download various parameters and profiles (e.g., an intake velocity profile) to the data system 34.

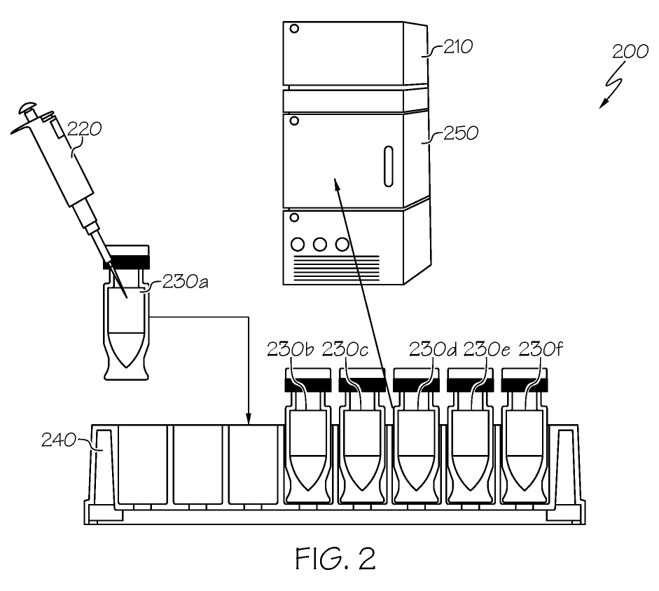

FIG. 2 depicts a manual workflow 200 for creating a calibration curve for a liquid chromatography system 210 in accordance with a prior art method. As shown, a manual pipette 220 is deployed by a lab technician to manually dilute multiple known concentrations of a sample or calibrant. The multiple known concentrations of the sample or calibrant are each individually contained within a plurality of standard lab vials 230a, 230b, 230c, 230d, 230e, 230f. Thus, the manual workflow 200 requires the lab technician to mix a sample or calibrant to various known and precise concentrations with a diluent, and ensure these known concentrations of the calibrant are accurately placed within the individual standard lab vials 230a, 230b, 230c, 230d, 230e, 230f at known positions within a sample vial tray 240. The sample vial tray 240 is then inserted into a sample manager 250 whereby a sample injection system within the sample manager then draws and injects each of the known concentrations into the liquid chromatography system 210 to obtain a detection response.

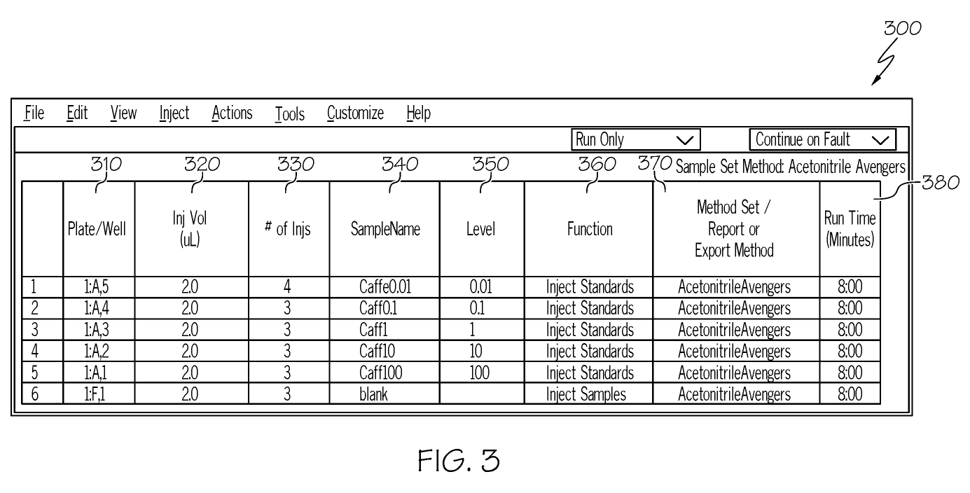

FIG. 3 depicts a data input user interface 300 requiring manual entries of information in accordance with the prior art method. As shown, the data input user interface 300 includes various columns associated with data entry, including a plate and/or well position column 310, an inject volume column 320, a number of injections column 330, a sample name column 340, a concentration level column 350, a function column 360, a method description column 370, and a runtime column 380.

The data entry associated with the columns may be prone to human error. For example, if a plate position is misidentified as an entry in the plate and/or well position column 310 and/or if the concentration levels entered into column 350 are improper, the entire calibration process will be faulty and need to be re-run. Thus, the manual workflow 200 requires the accurate entry of data corresponding to accurately concentrated samples of calibrant at accurately identified well positions.

The various manual processes described in FIGS. 2 - 3 in the prior art calibration methodology are both time consuming and open the possibility for various forms of manual errors, such as sample preparation errors and transcription errors. Any error that occurs results in an entire calibration process or methodology which must be redone. Such calibration processes are often time consuming and costly. Moreover, if a calibration error is not detected until after experimentation on actual samples based on the calibration is conducted, such experimentation must be discarded. Embodiments of the present invention described herein below substantially reduce the potential for these errors to occur.

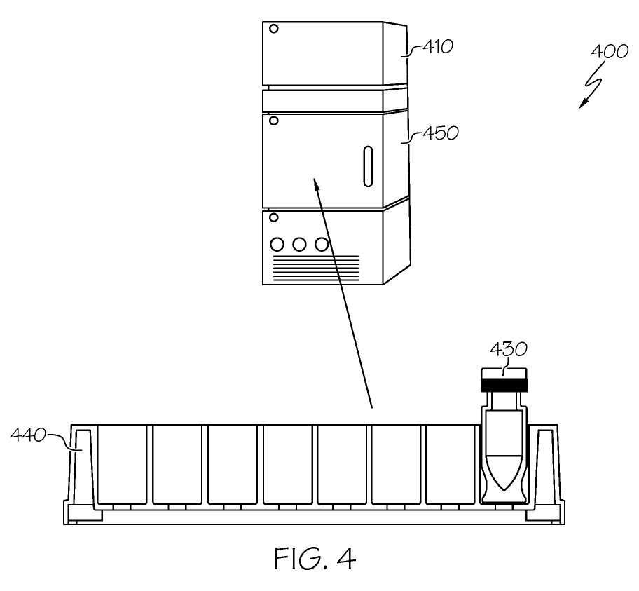

FIG. 4 depicts an automated workflow 400 for creating a calibration curve for a liquid chromatography system 410, in accordance with one embodiment. Unlike the manual workflow 200, the automated workflow 400 simply requires a lab technician to insert a concentrated sample or calibrant (i.e., a sample) into a sample manager 450 of the liquid chromatography system 410. As shown, this one concentrated sample or calibrant 430 may be provided within a sample vial tray 440.

Once inserted into a receptor of the sample manager 450, the sample manager 450 may include a calibration system configured to, without human intervention, automatically generate a calibration curve using the submitted sample at multiple concentrations after receiving information including a known concentration of the received sample. The receptor of the sample manager 450 may be a tray or plate configured to receive a sample vial and/or a tray or plate configured a removable or insertable sample vial tray 440 as shown in FIG. 4. Once the single concentrated source of sample or calibrant is received by the receptor of the sample manager 450, the sample manager 450 and/or calibration system may then be configured to automatically perform the calibration procedure without human intervention and report the automatically generated calibration curve to a user interface in communication with the liquid chromatography sample manager system 450.

The “calibration system” of the sample manager 450 and/or liquid chromatography system 410 herein may include any or all of the features and functionality of the sample manager 450 and/or liquid chromatography system 410 that are necessary in order to perform the dilution and/or calibration techniques described herein. Such features may be the same features used by the sample manager to dilute, draw, inject, separate and/or detect unknown samples during a testing procedure. Thus, the “calibration system” may include, but not be limited to, an automated sample needle system for drawing a sample from a sample vial received by the sample manager receptor, diluting the received sample, a tray configured to hold one or more vials, a washing system configured to reduce carryover after each iterative calibration injection, a control system configured to receive calibration methodology inputs from a user and implement the calibration methodologies in accordance with those inputs, an injection system for receiving injected calibrants at various concentrations, a detection system for detecting the concentrations of the injected calibrants pursuant to the calibration process, and a calibration curve generation system and/or UI associated with displaying a generated calibration curve.

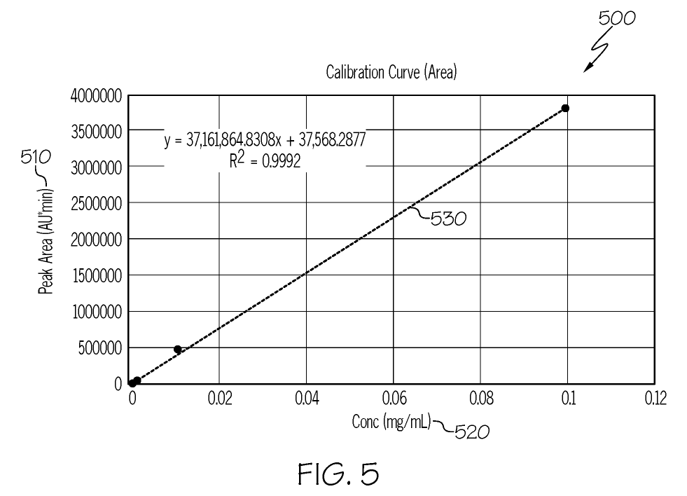

FIG. 5 depicts a calibration curve 500 generated by the automated workflow 400 of FIG. 4, in accordance with one embodiment. This calibration curve 500 may be provided, via a user interface or display, to a user or lab technician. The calibration curve 500 includes a curve 530 plotting peak area 510 (in AU * minutes) versus sample or calibrant concentration 520. The curve 530 represents a best fit function of this plot associated with concentrations of the sample or calibrant as detected by a detector in the liquid chromatography system 410. However, the calibration curve 500 may be generated without any manual dilution procedures, or manual input of sample coordinates within a sample vial tray.

To generate the calibration curve 500, the calibration system may be configured to receive inputs from a user or lab technician, such as a concentration of the single concentrated calibrant received within the vial 430, a calibration curve range of concentrations desired, an injection volume for injections of the various concentrations of calibrant or sample, the number of calibrants within the range, the number of replication injections at each concentration, and/or the calibrant consumption. The calibration system may then be configured to automatically determine a dilution procedure to create the multiple concentrations using the calibration curve range and any other received inputs from the lab technician.

In some embodiments, rather than providing a calibration curve range and having the calibration system automatically determine the specific concentrations, a user or lab technician may specify exact target concentrations to be used for generating the calibration curve. For example, the calibration system may be configured to receive a plurality of user-specified target concentrations via a user interface, and the calibration system may then be configured to automatically dilute the sample to each of the user-specified target concentrations. This approach may provide the user with greater control over the calibration process, particularly in cases where specific concentration values are required by regulatory standards or laboratory protocols.

In some embodiments, the calibration system may include or be in communication with a software tool configured to automatically generate a series of lines or entries within a sample set method of a chromatography data system (CDS) software, such as Empower or similar chromatography data system software. Each line or entry within the sample set method may correspond to a concentration level for the calibration curve. For example, upon receiving the calibration inputs from the user (such as the calibration curve range, the number of concentrations, the number of replicate injections at each concentration, and/or the user-specified target concentrations), the software tool may automatically populate the sample set method with the appropriate number of lines, each line including the relevant parameters for that concentration level such as the vial position, injection volume, sample name, concentration value, and number of injections. This automated generation of sample set method entries may eliminate the need for manual data entry as shown in the prior art data input user interface 300 of FIG. 3, thereby reducing the potential for transcription errors and improving workflow efficiency.

In order to create the calibration curve, the calibration system may then be configured to automatically dilute the sample in accordance with the dilution procedure to multiple concentrations required by the dilution procedure. For example, in one embodiment, the calibration system may receive the sample or calibrant 430 in addition to several empty vials and/or diluent. The calibration system may be configured to automatically draw the sample or calibrant from the received sample vial, and automatically perform mixing and diluting of a first concentration in a first of the empty vials, a second concentration in a second of the empty vials, etc. Between each drawing and diluting step, the calibration system may be configured to automatically wash the fluidics of the liquid chromatography sample manager system used while diluting each of the multiple concentrations to reduce response carry over.

Moreover, the calibration system may be configured to inject the multiple concentrations into a liquid chromatography system and then detect each of the multiple concentrations. The calibration system may be further configured to automatically wash the fluidics of the liquid chromatography sample manager system used while generating the calibration curve after the injecting of each of the multiple concentrations to reduce response carry over.

In some embodiments, the automation system may be configured to generate the various samples first, followed by sequentially injecting the prepared samples for detection in succession in accordance with the determined calibration process. In other embodiments, the automation system may be configured to generate one known sample concentration, followed by injecting that known sample concentration for detection, and repeating this dilution and injection process for each other required sample concentration in the calibration process.

The washing of the system may include using a water or cleaning process on any of the fluidic components that were used in diluting and/or injecting and/or detecting the sample during the automated calibration process before a next stage of the calibration process occurs. Such a washing process may include receiving a washing fluid (e.g., water) from a source and flowing this fluid through the components of the system to reduce the response carry over to .002% units or less, for example.

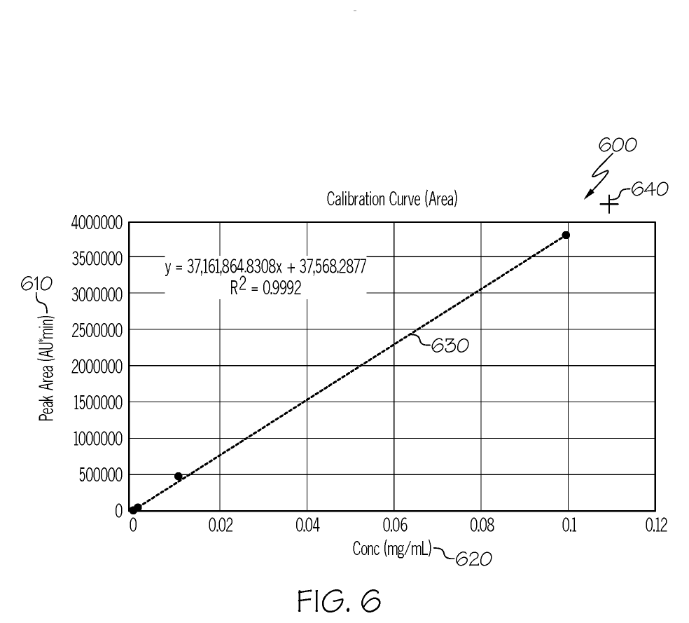

The sample managers described herein may further be configured to leverage the automated dilution capabilities described herein to automatically re-inject an unknown sample which falls outside the area of a generated calibration curve. For example, FIG. 6 depicts a calibration curve 600 having an unknown concentration 640 detected outside the calibration curve 600, in accordance with one embodiment. In particular, the calibration curve 600 includes a curve 630 plotting peak area 610 (in AU * minutes) versus sample or calibrant concentration 620. Like the curve 530, the curve 630 represents a best fit function of this plot associated with concentrations of the sample or calibrant as detected by a detector in the liquid chromatography system 410. The calibration curve 600 may be generated without any manual dilution procedures, or manual input of sample coordinates within a sample vial tray.

As shown in FIG. 6, a sample of unknown concentration is tested by the liquid chromatography system 410 after calibration. The concentration of the sample is determined to be outside of the area of the calibration curve, as shown in the calibration curve 600. In this embodiment, the sample manager (e.g., the sample manager 450) and/or the calibration system thereof may be configured to detect that the unknown concentration is outside a calibration curve range of the calibration curve. Then, the sample manager and/or the calibration system thereof may be configured to automatically dilute the sample of unknown concentration with a known dilution ratio that results in the concentration to be inside the calibration curve range. Then, the sample manager may be configured to inject the sample of unknown concentration with the known dilution ratio into the liquid chromatography system.

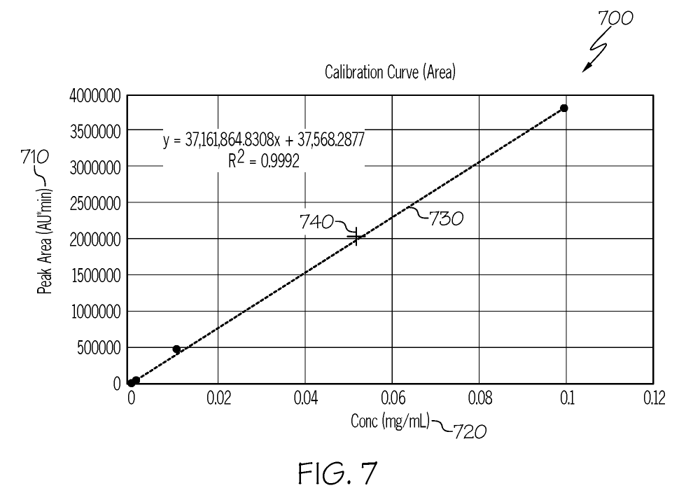

FIG. 7 depicts a calibration curve 700 particularly including a curve 730 plotting peak area 710 (in AU * minutes) versus sample or calibrant concentration 720 having the unknown concentration 740 now detected inside the calibration curve 700 after such an automated dilution process, in accordance with one embodiment. It should be understood that such a dilution process may include a plurality of dilution steps to fully dilute the sample such that the sample remains within the area of the calibration curve. The sample manager and/or calibration system thereof may be configured to automatically determine how much dilution is require to ensure that the resulting sample concentration remains within the calibration curve range. This may ensure the accuracy of the detection, and prevent testing detections of unknowns outside a calibration curve range where the accuracy of the detector may not ensured by the calibration process.

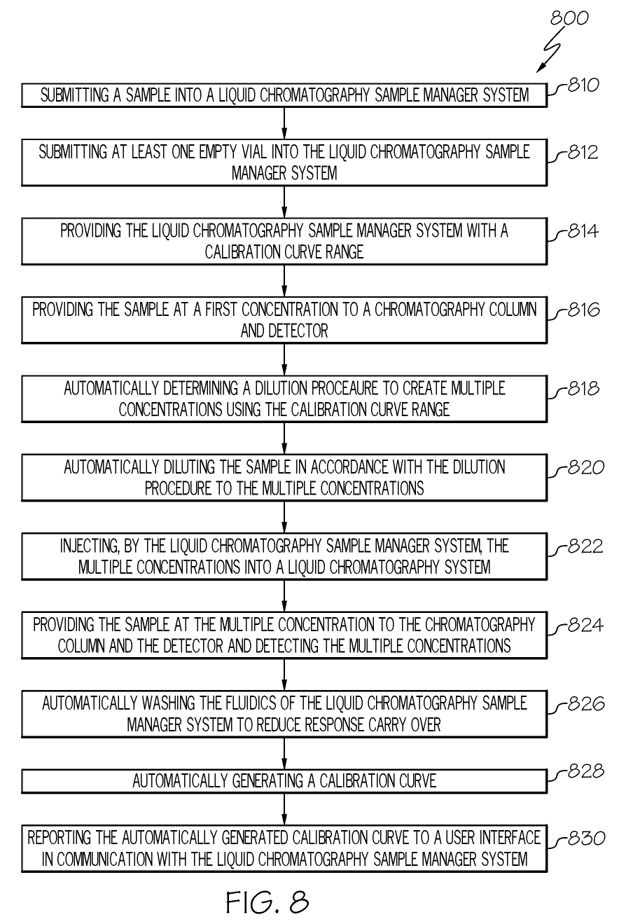

FIG. 8 depicts a method 800 for performing liquid chromatography calibration, in accordance with one embodiment. The method 800 includes a first step 810 of submitting a sample into a liquid chromatography sample manager system. The method 800 may further include a step 812 of submitting one or more empty vials into the liquid chromatography sample manager. The at least one empty vial may be used by the liquid chromatography sample manager system for diluting the sample and creating the multiple concentrations during a dilution process.

The method 800 may then include a step 814 of providing the liquid chromatography sample manager system with one or more calibration inputs from a user or lab technician, such as a calibration curve range. Other inputs may include a known concentration of the sample. The method 800 may further include a step 816 of providing the sample at a first concentration to a chromatography column and detector.

The method 800 may then include a step 818 of creating or automatically determining a dilution process or procedure to create the multiple concentrations using the calibration curve range, and a step 820 of automatically diluting, by the liquid chromatography sample manager system, the sample in accordance with the dilution procedure to the multiple concentrations required by the created or automatically generated dilution process. Methods may include using a complex biological matrix as a diluent when creating the multiple concentrations of the sample. The method 800 may then include a step 822 of injecting, by the liquid chromatography sample manager system, the multiple concentrations into a liquid chromatography system. The method 800 may include a step 824 of providing the sample the multiple concentrations to the chromatography column and the detector and detecting the multiple concentrations. This may occur sequentially rather than simultaneously.

The method 800 may then include a step 826 of automatically washing, by the liquid chromatography sample manager system, the fluidics of the liquid chromatography sample manager system used during the automatically generating the calibration curve after the automatically diluting and/or injecting of each of the multiple concentrations to reduce response carry over.

Finally, a step 828 includes automatically generating, by the liquid chromatography sample manager system, a calibration curve using the concentrated sample at multiple concentrations, and a step 830 of reporting the automatically generated calibration curve to a user interface in communication with the liquid chromatography sample manager system.

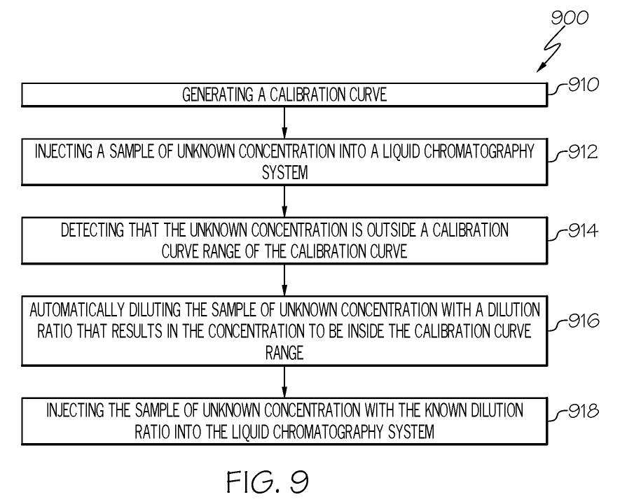

FIG. 9 depicts a method 900 for automatically detecting that an unknown concentration is outside a calibration curve and performing an auto dilution process on a sample, in accordance with one embodiment. The method 900 may include a step 910 of generating a calibration curve by a sample manager system in accordance with any appropriate manner, including but not limited to those described in the embodiments herein. The method 900 may include a step 912 of injecting a sample of unknown concentration into a liquid chromatography system, and a step 914 of detecting, by the liquid chromatography sample manager system, that the unknown concentration is outside a calibration curve range of the calibration curve. The method 916 may include a step 918 of automatically diluting, by the liquid chromatography sample manager system, the sample of unknown concentration with a known dilution ratio that results in the concentration to be inside the calibration curve range, and a further step of injecting, by the liquid chromatography sample manager system, the sample of unknown concentration with the known dilution ratio into the liquid chromatography system. The automatic dilution in accordance with the method 900 may include using a plurality of dilution stages to further dilute the sample if necessary to arrive at a concentration within the calibration curve range.

While various examples have been shown and described, the description is intended to be exemplary, rather than limiting and it should be understood by those of ordinary skill in the art that various changes in form and detail may be made therein without departing from the scope of the invention as recited in the accompanying claims.

1. A method for performing liquid chromatography calibration comprising:
submitting a sample into a liquid chromatography sample manager system;
 providing the liquid chromatography sample manager system with a known concentration of the sample;
providing, by the liquid chromatography sample manager system, the sample at a first concentration to a chromatography column and detector;
providing the sample at a second concentration to the chromatography column and the detector; and
automatically generating, by the liquid chromatography sample manager system, a calibration curve after detecting the sample at multiple concentrations including the first concentration and the second concentration.

2. The method of claim 1, further comprising:
 reporting the automatically generated calibration curve to a user interface in communication with the liquid chromatography sample manager system.

3. The method of claim 1, further comprising:
prior to the automatically generating the calibration curve, providing the liquid chromatography sample manager system with a calibration curve range.

4. The method of claim 3, further comprising:
automatically determining, by the liquid chromatography sample manager system, a dilution procedure to create the multiple concentrations using the calibration curve range;
automatically diluting, by the liquid chromatography sample manager system, the sample in accordance with the dilution procedure to the multiple concentrations; and
injecting, by the liquid chromatography sample manager system, each of the multiple concentrations into a liquid chromatography system.

5. The method of claim 1, further comprising:
 automatically washing, by the liquid chromatography sample manager system, the fluidics of the liquid chromatography sample manager system used during the automatically generating the calibration curve after the automatically diluting and injecting of each of the multiple concentrations to reduce response carry over, wherein the response carry over is 0.02% units or less.

6. The method of claim 1, further comprising:
 submitting at least one empty vial into the liquid chromatography sample manager system, wherein the at least one empty vial is used by the liquid chromatography sample manager system for diluting the sample and creating the multiple concentrations.

7. The method of claim 1, further comprising:
 injecting a sample of unknown concentration into a liquid chromatography system;
 detecting, by the liquid chromatography sample manager system, that the unknown concentration is outside a calibration curve range of the calibration curve;
 automatically diluting, by the liquid chromatography sample manager system, the sample of unknown concentration with a dilution ratio that results in the concentration to be inside the calibration curve range; and
 injecting, by the liquid chromatography sample manager system, the sample of unknown concentration with the dilution ratio into the liquid chromatography system, wherein the automatically diluting includes a plurality of dilution stages.

9. The method of claim 1, further comprising using a complex biological matrix as a diluent when creating the multiple concentrations of the sample.

10. The method of claim 1, further comprising:
 receiving, by the liquid chromatography sample manager system, a plurality of user-specified target concentrations, wherein the multiple concentrations include the plurality of user-specified target concentrations.

11. The method of claim 1, further comprising:
 receiving, by the liquid chromatography sample manager system, a number of concentrations to be used for generating the calibration curve.

12. The method of claim 1, further comprising:
 receiving, by the liquid chromatography sample manager system, a number of replicate injections to be performed at each of the multiple concentrations.

13. A liquid chromatography sample manager comprising:
 a receptor configured to receive a sample; and
 a calibration system configured to:
 receive information including a known concentration of the sample;
 provide the sample at a first concentration to a chromatography column and detector;
provide the sample at the second concentration to the chromatography column and the detector; and
without human intervention, automatically generate a calibration curve after detecting the sample at multiple concentrations including the first concentration and the second concentration.

13. The liquid chromatography sample manager of claim 12, wherein the calibration system is further configured to receive a calibration curve range from a user and automatically determine a dilution procedure to create the multiple concentrations using the calibration curve range, and wherein the calibration system is further configured to receive a number of calibrants and/or the number of replicate injections at each concentration of the multiple concentrations to generate the calibration curve.

14. The liquid chromatography sample manager of claim 12, wherein the calibration system is further configured to receive a plurality of user-specified target concentrations, wherein the multiple concentrations include the plurality of user-specified target concentrations

15. The liquid chromatography sample manager of claim 13, wherein the calibration system is further configured to:
 automatically dilute the sample in accordance with the dilution procedure to the multiple concentrations;
 inject the multiple concentrations into a liquid chromatography system; and
 automatically wash the fluidics of the liquid chromatography sample manager system used while generating the calibration curve after automatically diluting and injecting of each of the multiple concentrations to reduce response carry over, wherein the response carry over is 0.02% units or less.

16. The liquid chromatography sample manager of claim 12, wherein the receptor is further configured to receive at least one empty vial, wherein the at least one empty vial is used by the liquid chromatography sample manager system for diluting the sample and creating the multiple concentrations.

17. The liquid chromatography sample manager of claim 12, wherein the calibration system is further configured to:
 inject a sample of unknown concentration into a liquid chromatography system;
 detect that the unknown concentration is outside a calibration curve range of the calibration curve;
 automatically dilute the sample of unknown concentration with a dilution ratio that results in the concentration to be inside the calibration curve range; and
 inject the sample of unknown concentration with the dilution ratio into the liquid chromatography system.

18. A method for performing liquid chromatography comprising:
 generating, by a liquid chromatography system, a calibration curve;
 injecting a sample of unknown concentration into a liquid chromatography system; and
 detecting, by the liquid chromatography system, that the unknown concentration is outside a calibration curve range of the calibration curve.

19. The method of claim 18, further comprising:
 automatically diluting, by the liquid chromatography system, the sample of unknown concentration with a dilution ratio that results in the concentration to be inside the calibration curve range in response to the detecting, by the liquid chromatography system, that the unknown concentration is outside the calibration curve range of the calibration curve;
 injecting, by the liquid chromatography system, the sample of unknown concentration with the dilution ratio into the liquid chromatography system, wherein the automatically diluting includes a plurality of dilution stages.

20. The method of claim 18, further comprising reporting the calibration curve to a user interface in communication with the liquid chromatography system.
